(19) United States
(12) Patent Application Publication
(10) Pub. No.: US 2008/0251407 A1
(43) Pub. Date: Oct. 16, 2008

(54) PLASTICS COMPOSITION AND PRODUCTS THEREOF

(76) Inventors: Henning Johannes Visser, Pretoria (ZA); Lorita Marlena Diem, Kyalami Estates (ZA)

Correspondence Address: HAHN AND MOODLEY, LLP, P.O. BOX 52050, MINNEAPOLIS, MN, 55402, US

(21) Appl. No.: 12/111,663

(22) Filed: Apr. 29, 2008

Related U.S. Application Data
(63) Continuation of application No. PCT/ZA2006/000016, filed on Feb. 1, 2006.

(30) Foreign Application Priority Data
Sep. 29, 2005 (ZA) 2005/07866

(51) Int. Cl. B65D 65/38; C08L 33/02; B29C 47/00

(52) U.S. Cl. 206/497; 524/522; 264/148

(57) ABSTRACT

The invention provides a plastics composition including polyethylene terephtalate (PET), chain extending agent, compatibilising agent, and one or more of polyolefin (PO), polyamide (PA), and vinyl thermoplastics. The plastics composition may include one or more of an impact modifier, an extrusion aid, lubricant, a reinforcing filler, flame retardant, organic filler, foaming agent or other modifying additive. The plastics composition may be a thermoplastics composition. The PET may include post consumer PET. At least 30% by mass of the PET may be post consumer PET, typically at least 50% by mass, and even in excess of 90% by mass. It may also be 100% virgin—of all the different grades commercially available—inclusive of PET G co-polymer. The invention extends to a process and to items made of the composition.

This is a continuation of International Application PCT/ZA2006/000016, with an international filing date of Feb. 1, 2006, now abandoned, which application claims the benefit of priority to South African patent application 2005107866 filed Sep. 29, 2005.

### FIELD

The invention relates to a plastics composition and to products produced therefrom.

### BACKGROUND

The inventors are aware of a need for a plastics compositions which is extrudable and which can be used for load bearing purposes, such as for elements of pallets, boxes, as well as pipes, and the like.

Yet further, there is a need to recycle PET and Polyolefins as these are used in vast quantities for the manufacture of bottles, containers, and other disposable uses.

Present compositions which attempt to combine PET and Polyolefins do not form a stable melt and are thus not suitable for extrusion into components such as square tubing, piping, and the like. PET or any composition thereof requires drying prior to processing to prevent hydrolysis which leads to weaker mechanical and other physical properties.

Discarded, also called post-consumer, PET bottles have limited use as recycled materials and cannot be formed into useful products using conventional processes and equipment which are currently used for the processing of Polyolefins.

Thus, after extensive research and experimentation, the inventors propose a plastics composition which addresses at least some of the above needs and solves at least some of the above problems, at least to a limited extent.

The inventors also propose a profiled member and a process for manufacturing said member from such a plastics composition.

### SUMMARY

According to a first aspect of the invention, there is provided a plastics composition including polyethylene terephtalate (PET), chain extending agent, compatibilsing agent, and one or more of polyolefin (PO), polyamide (PA), and vinyl thermoplastics.

The plastics composition may include one or more of an impact modifier, an extrusion aid, lubricant, a reinforcing filler, flame retardant, organic filler, foaming agent or other modifying additive.

The plastics composition may be a thermoplastics composition.

The PET may include post consumer PET. At least 30% by mass of the PET may be post consumer PET, typically at least 50% by mass, and even in excess of 90% by mass. It may also be 100% virgin—of all the different grades commercially available—inclusive of PET G co-polymer.

Likewise, the PO may include post consumer PO. At least 30% by mass of the PO may be post consumer PO, typically at least 50% by mass, and even in excess of 90% by mass. It may also be 100% virgin—of all grades commercially available

The plastics composition may include from 30 mass % to 90 mass % PET, possibly from 64 mass % to 80 mass % PET.

The plastics composition may include from 15 mass % to 60 mass % of one or more of PO, PA or vinyl thermoplastics, possibly from 15 mass % to 27 mass % thereof.

The plastics composition may include from 1 mass % to 10 mass % compatibilising agent.

The plastics composition may include from 1 mass % to 10 mass % impact modifier.

The plastics composition may include from 0.2 mass % to 5 mass % chain extender.

The plastics composition may include from 5 mass % to 50 mass % reinforcing filler.

The plastics composition may include from 5 mass % to 40 mass % organic filler.

The plastics composition may include from 1 mass % to 10 mass % flame retardant.

The PET may include post consumer recycled material, recycled bottles, originally manufactured from commercial PET grades. The PET may however include or be 100% virgin PET.

The PO may include post consumer HDPE, recycled PO, blowmoulding PO. Virgin PO may also be used.

In one embodiment, the plastics composition comprises 71 mass % PET. The PET may be post consumer PET.

The plastics composition of the above embodiment may comprise 20 mass % HDPE, typically post consumer HDPE.

The compatibilising agent may be maleic anhydride.

The impact modifier may be ethylene/n-butyl acrylate/glycidil metacrylate.

The chain extender may be carbonylbiscaprolactum, phenylenebisoxazoline or a multifunctional oligomeric material.

The plastics composition of the above embodiment may include 5 mass % compatibilising agent, 3 mass % impact modifier/extrusion aid, and 1 mass % chain extender.

According to a second aspect of the invention, there is provided a process for the production of a profiled member manufactured from a plastics composition as described above, said process including the steps of:
a) granulating one or more of the PET, PO, PA, and vinyl thermoplastics;
b) optionally, washing and drying one or more of the PET, PO, PA, and vinyl thermoplastics prior to the granulating step a);
c) compounding the granulated plastics material from the granulation step a) with at least the chain extending agent, impact modifier/extruding agent and the compatibilising agent in the amounts set out above at a temperature of at least 200° C.;
d) pelletising the compounded plastics material from step c);
e) optionally, dehumidifying the granules from step a); and
f) forming the profiled member by extrusion of the plastics composition at a temperature of above 200° C.

The compounding may be carried out in a compounding extruder of which the heating body is at about 260° C. and the residence time of the plastics material in the extruder is from 30 seconds to 15 minutes, typically from 1 to 4 minutes. The temperature and residence time are a function of the length of the extruder screw, its pitch, the components of the plastics composition, the size of the extruder's orifice, and the speed of rotation of the screw.

The forming may be by use of a forming extruder the body of which is heated to about 240° C., and into which the compounded granules from step c) mixed into a homogeneous paste are fed and urged by the extruder screw through a shaped extrusion die whereafter the formed melt is pulled by a haul-of device through a water cooled calibrator of similar outside dimensions and shape as the extrusion dye, which calibrator is water cooled in a negative pressure vessel, the melt being further cooled by water spray nozzles.

The forming step f) may be followed by a cutting step in which the formed profile is cut to the required length.

The forming may be carried out a rate of from 2 m/min to 15 m/min.

The invention extends to an assembled item of commerce comprising of a number of formed profiles.

The assembled item may be a palette used in transport of goods, for example, by road, rail or ship.

### DESCRIPTION

The invention will now be described, by way of non-limiting example only, with reference to the examples which follow.

### EXAMPLE 1

A round profile was prepared from a plastics composition which comprised by weight:
71 mass % PET
20 mass % HDPE
5 mass % compatibilising agent
3 mass % impact modifier/extrusion aid
1 mass % chain extender

The compatibilising agent was Fusabond™ EMB-1000

The impact modifier was Elvaloy™ PTW.

The chain extender was Cesa™.

### EXAMPLE 2

A square profile was prepared using the same composition as per example 1.

The extruder used for examples 1 and 2 was a 70 mm single screw extruder, with the barrel temperature range used being from 180 to 250° C., the screw speed being 30 r.p.m. and the melt pressure 70 bar and a melt temperature of 245° C.

The invention permits the plastics composition to be:
directly extrudable without pre-drying;
processable on conventional plastics processing machinery which may vary in kind, size, and combination according to the process required to produce a required product, including but not limited to pipe extrusion, film extrusion, and sheet extrusion, injection moulding, blow moulding, thermoforming, cast sheet extrusion, compression, compression, rotational moulding, and autoclave forming, or any other similar process;
melted, stabilized and formed into a variety of products; and
weldable, glueable, bindable, machinable or otherwise formable to form other end products.

### EXAMPLE 3

A flat sheet was manufactured using the same composition as that in Example 1.

The width of the sheet was 1000 mm and thickness 300 micron, 600 micron, 1.1 mm, and 2.5 mm.

An 80 mm extruder with a flat die cast film “T” die was used to extrude the compound.

The melt was then fed into chilled calendaring rollers after which it was wound onto reels.

The material was used to vacuum/thermo form punnets, like those used for fast foods.

The inventor believes that a palette made in accordance with the invention is advantageous as it allows post consumer PET and PO to be used in a commercially viable product.

1. A process for the extrusion of a profiled member manufactured from a plastics composition including polyethylene terephtalate (PET), chain extending agent, compatibilsing agent, and one or more of polyolefin (PO), polyamide (PA), and vinyl thermoplastics, said process including the steps of:
granulating one or more of the PET, PO, PA, and vinyl thermoplastics;
optionally, washing and drying one or more of the PET, PO, PA, and vinyl thermoplastics prior to the granulating step a);
compounding the granulated plastics material from the granulation step a) with at least the chain extending agent, impact modifier/extruding agent and the compatibilising agent in the amounts set out above at a temperature of at least 200° c.;
pelletising the compounded plastics material from step c);
optionally, dehumidifying the granules from step a); and
f) forming the profiled member by extrusion of the plastics composition at a temperature of above 200° C., wherein the forming is by use of a forming extruder the body of which is heated to about 240° C., and into which the compounded granules from step c) mixed into a homogeneous paste are fed and urged by the extruder screw through a shaped extrusion die whereafter the formed melt is pulled by a haul-of device through a water cooled calibrator of similar outside dimensions and shape as the extrusion dye, which calibrator is water cooled in a negative pressure vessel, the melt being further cooled by water spray nozzles.

2. A process as claimed in claim 1, wherein the plastics composition includes one or more of an impact modifier, and extrusion aid, lubricant, a reinforcing filler, flame retardant, organic filler, foaming agent or other modifying additives.

3. A process as claimed in claim 1, wherein the PET includes at least 64 mass % post consumer PET.

4. A process as claimed in claim 1, wherein the PO includes less than 27 mass % post consumer PO.

5. A process as claimed in claim 1, wherein the plastics composition wherein the plastics composition includes 71 mass % PET.

6. A process as claimed in claim 1, wherein the compounding is carried out in a compounding extruder of which the heating body is at about 260° C. and the residence time of the plastics material in the extruder is from 30 seconds to 15 minutes.

7. A process as claimed in claim 6, wherein the residence time is from 1 to 4 minutes.

8. A process as claimed in claim 1, wherein the forming step f) is followed by a cutting step in which the formed profile is cut to the required length.

9. A process as claimed in claim 8, wherein the forming is carried out a rate of from 2 m/min to 15 m/min.

10. An assembled item of commerce comprising of a number of formed profiles made from a composition made by a process as claimed in claim 1.

11. An assembled item as claimed in claim 10, wherein the assembled item is a palette used in transport of goods.

12. A punnet made by extrusion from a composition as made by a process as claimed in claim 1.
